(19) United States
(12) Patent Application Publication
(10) Pub. No.: US 2007/0081350 A1
(43) Pub. Date: Apr. 12, 2007

(54) Rearview mirror and signal light arrangement

(76) Inventor: Chine-Shan Huang, Tainan City (TW)

Correspondence Address: PRO-TECHTOR INTERNATIONAL SERVICES, 20775 NORADA CT., SARATOGA, CA, 95070, US

(21) Appl. No.: 11/249,855

(22) Filed: Oct. 12, 2005

(51) Int. Cl. B60R 1/12

(52) U.S. Cl. 362/494

(57) ABSTRACT

A rearview mirror and signal light arrangement is disclosed to include a rearview mirror, a lens fastened to the back side of the rearview mirror, and plurality of light emitting devices mounted inside the rearview mirror and electrically connected to the power circuit of one lamp of the car for emitting light through specific light-permeable portions of the lens to give a visual warning signal to the cars approaching from behind.

### BACKGROUND OF THE INVENTION

1. Field of the Invention

The present invention relates to vehicle rearview mirrors and more particularly, to a rearview mirror and signal light arrangement, which gives a visual warning signal through light-permeable portions of a lens at the back side of the rearview mirror upon the operation of one specific light of the car.

2. Description of the Related Art

A conventional rearview mirror signal structure A (see FIG. 1) is known comprising a rearview mirror 100, which has a back recess 102, a plurality of lamp bulbs 101 installed in the back recess 102, and a cover shell 200 fastened to the back recess 102 and covered over the lamp bulbs 101. The cover shell b200b admits light. When turned on the directional light of the car, the lamp bulbs 101 are driven to flash, giving a warning signal. According to this design, the warning signal is not strong and not very indicative to other cars coming at a distance from behind because the light of the lamp bulbs 101 is diffused through the cover shell 200.

### SUMMARY OF THE INVENTION

The present invention has been accomplished under the circumstances in view.

According to one aspect of the present invention, the rearview mirror and signal light arrangement comprises a rearview mirror, at least one light emitting device mounted in the rearview mirror and extending toward the back side of the rearview mirror, and a lens fastened to the back side of the rearview mirror. The lens has at least one light-permeable portion disposed near the border area for the passing of light rays from the at least one light emitting device to produce a visual warning signal.

According to another aspect of the present invention, the lens has a grained layer covering the at least one light-permeable portion to soften light rays passing from the at least one light emitting device through the at least one light-permeable portion.

### BRIEF DESCRIPTION OF THE DRAWINGS

FIG. 1 is an exploded view of a rearview mirror signal structure according to the prior art.

FIG. 2 is a sectional assembly view of a rearview mirror and signal light arrangement according to the present invention.

FIG. 3 is a sectional assembly view of an alternate form of the rearview mirror and signal light arrangement according to the present invention.

FIG. 3a is an enlarged view of part C of FIG. 2.

FIG. 4 is a plain view showing one embodiment of the lens according to the present invention.

FIG. 5 is a plain view showing another embodiment of the lens according to the present invention.

FIG. 6 is a plain view showing still another embodiment of the lens according to the present invention.

FIG. 7 is a plain view showing still another embodiment of the lens according to the present invention.

FIG. 8 is a plain view showing still another embodiment of the lens according to the present invention.

FIG. 9 is a plain view showing still another embodiment of the lens according to the present invention.

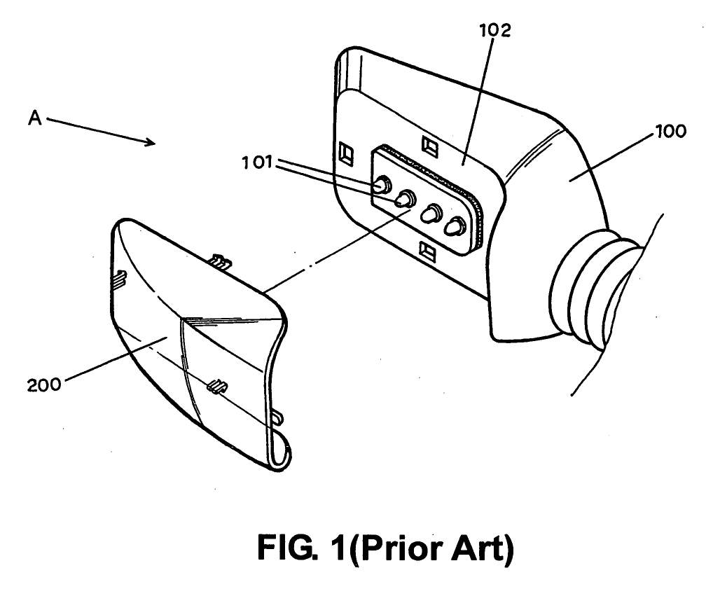

### DETAILED DESCRIPTION OF THE INVENTION

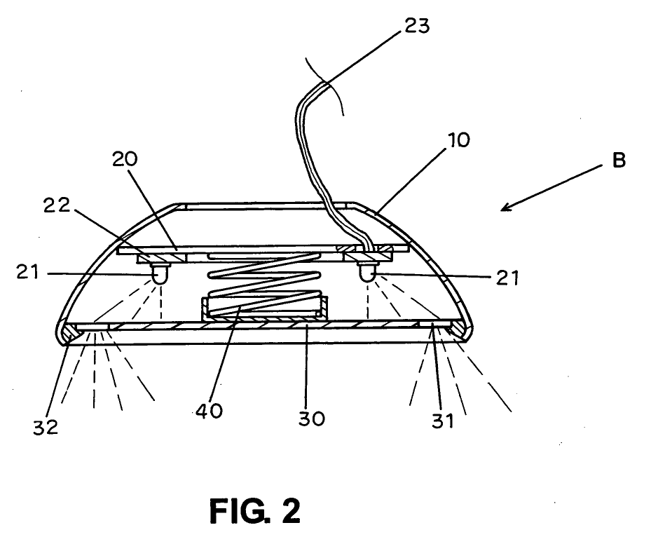

Referring to FIG. 2, a rearview mirror signal structure B in accordance with the present invention is shown comprising a rearview mirror 10, a mount 20 mounted in the rearview mirror 10, and a lens 30 fastened to the back side of the rearview mirror 10.

The mount 20 holds a circuit board 22, which has a plurality of light emitting devices 21 and an electric wire 23. The electric wire 23 extends out of the circuit board 22 for connection to the power circuit of the directional light of the car (not shown). The lens 30 has at least one, for example, multiple light-permeable portions 31 in the border area for the passing of the light from the light emitting devices 21. Further, a locating member 32 is fastened to the back side of the rearview mirror 10 to stop the lens 30 inside the rearview mirror 10. A spring member 40 is mounted inside the rearview mirror 10 and stopped between the circuit board 22 and the lens 30 to force the lens 30 against the locating member 32, holding the lens 30 in position.

When the car driver turned on the directional light, car battery power supply is simultaneously transmitted to the light emitting devices 21 through the circuit board 22, thereby causing the light emitting devices 21 to flash and to give a visual warning signal through the light-permeable portions 31 to the cars and/or passers-by approaching from behind (see FIG. 2).

The aforesaid electric wire 23 is electrically connected to the power circuit of the directional light of the car. Alternatively, the electric wire 23 can be connected to the power circuit of another lamp of the car (for example, headlight or night lamp) such that the light emitting devices 21 can be simultaneously turned on to give a visual warning signal upon operation of the respective lamp of the car.

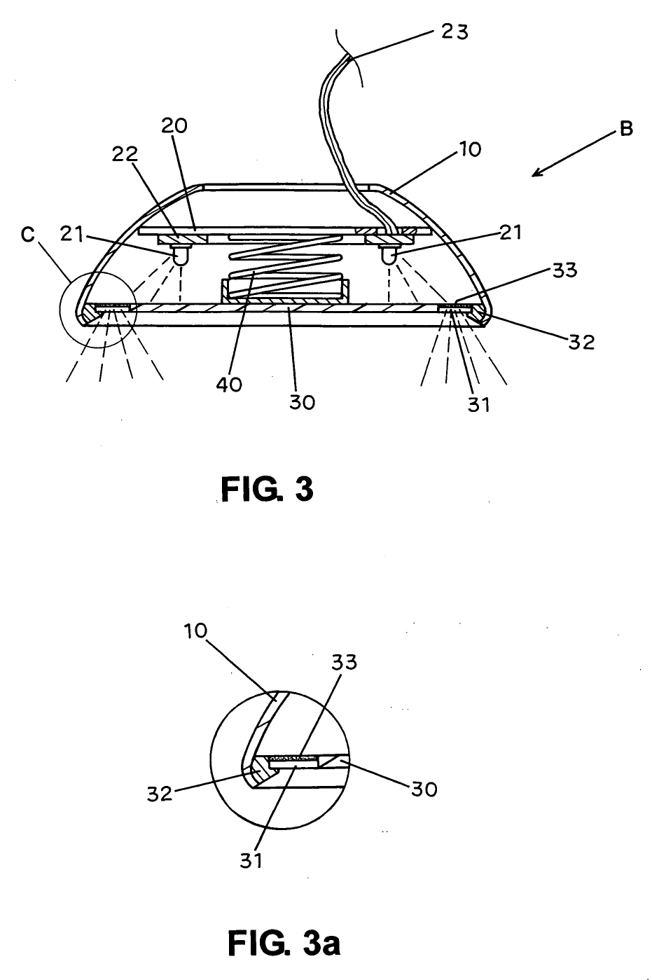

FIGS. 3 and 3a show an alternate form of the present invention. According to this embodiment, a grained layer 33 is covered on the light-permeable portions 31 of the lens 30 to soften the light passing from the light emitting devices 21 through the light-permeable portions 31, preventing dazzling of the visual warning signal to car driver's eyes.

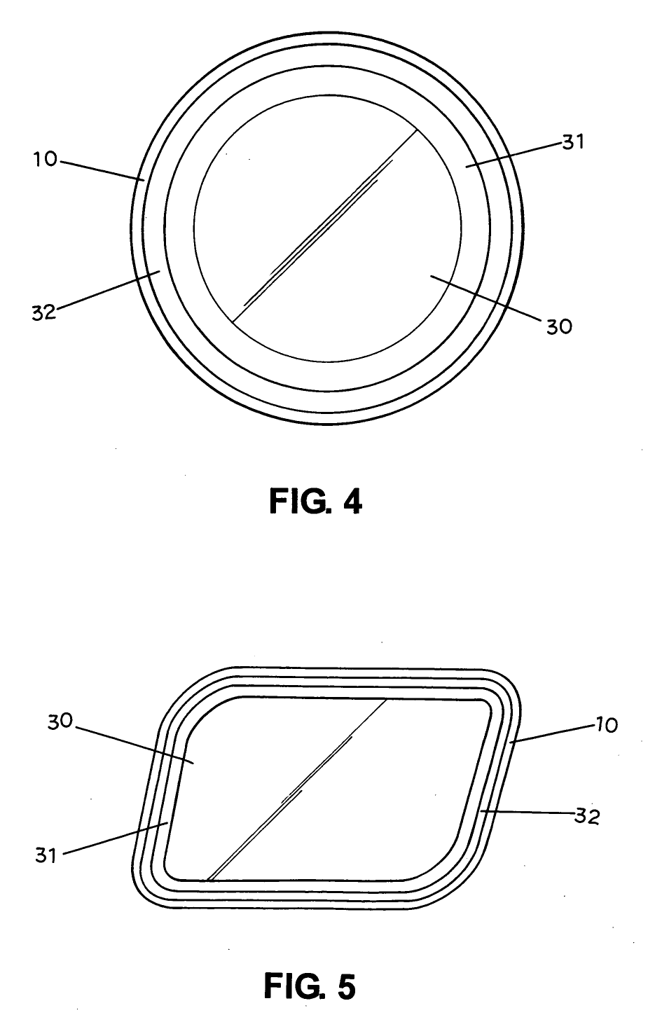

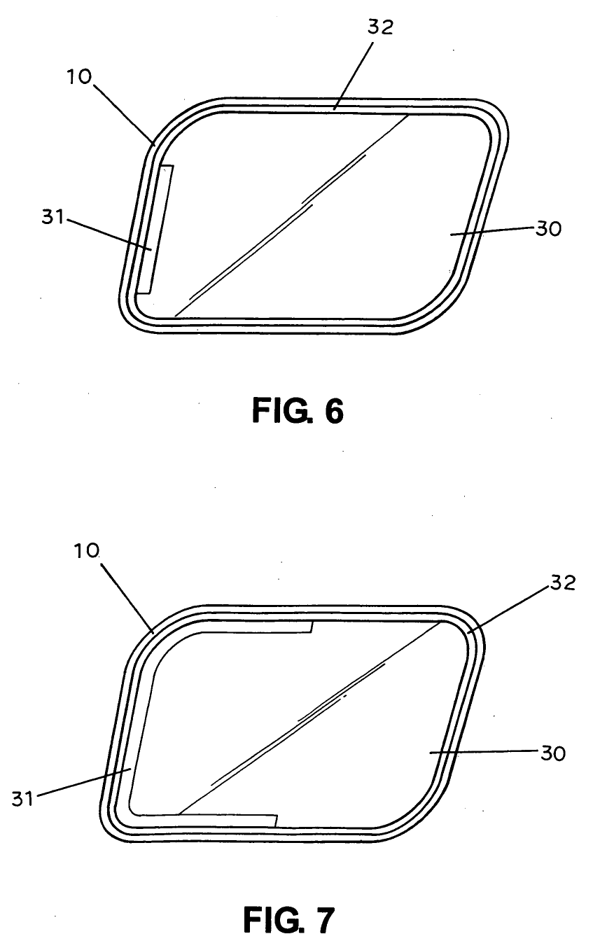

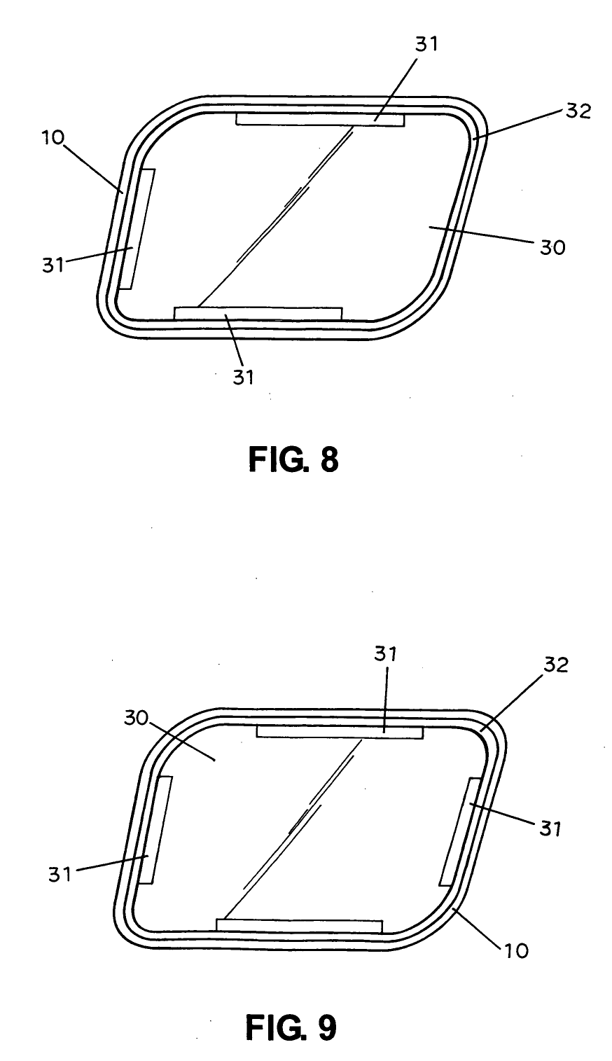

The lens 30 may be made in any of a variety of shapes. According to the embodiment shown in FIG. 4, the lens 30 is a circular lens having an annular light-permeable portion 31 extending along the border area. According to the embodiment shown in FIG. 5, the lens 30 is a quadrilateral lens having an endless light-permeable portion 31 extending along the border area. According to the embodiment shown in FIG. 6, the lens 30 is a quadrilateral lens having a narrow elongated light-permeable portion 31 extending along the outer lateral side. According to the embodiment shown in FIG. 7, the lens 30 is a quadrilateral lens having a narrow elongated light-permeable portion 31 extending along the outer lateral side, a part of the top side and a part of the bottom side. According to the embodiment shown in FIG. 8, the lens 30 is a quadrilateral lens having three narrow elongated light-permeable portions 31 respectively extending along the outer lateral side, the top side and the bottom side. According to the embodiment shown in FIG. 9, the lens 30 is a quadrilateral lens having four narrow elongated light-permeable portions 31 respectively extending along the four sides.

Further, the aforesaid light emitting devices 21 can be regular lamp bulbs or LEDs (light emitting diodes).

As indicated above, the invention provides a rearview mirror and signal light arrangement B, which uses light emitting devices 21 to emit light through light-permeable portions 31 of a lens 30 at the back side of the rearview mirror 10 upon operation of a specific light of the car, giving a visual warning signal to the cars approaching from behind.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rearview mirror and signal light arrangement comprising;
a rearview mirror, said rearview mirror having a back side;
at least one light emitting device mounted in said rearview mirror and extending toward the back side of said rearview mirror; and
a lens fastened to the back side of said rearview mirror, said lens having at least one light-permeable portion for the passing of light rays from said at least one light emitting device to produce a visual warning signal.

2. The rearview mirror and signal light arrangement as claimed in claim 1, wherein said at least one light-permeable portion is respectively disposed near the border of said lens.

3. The rearview mirror and signal light arrangement as claimed in claim 1, wherein said lens comprises a grained layer covering said at least one light-permeable portion to soften light rays passing from said at least one light emitting device through said at least one light-permeable portion.

4. The rearview mirror and signal light arrangement as claimed in claim 1, wherein said at least one light emitting device is respectively electrically connected to the power circuit of a lamp of a motor vehicle in which said rearview mirror is installed.

5. The rearview mirror and signal light arrangement as claimed in claim 1, further comprising a mount fixedly mounted inside said rearview mirror, and a circuit board supported on said mount and adapted to control the operation of said at least one light emitting device.

6. The rearview mirror and signal light arrangement as claimed in claim 5, further comprising a locating member fixedly fastened to the back side of said rearview mirror to stop said lens in place.

7. The rearview mirror and signal light arrangement as claimed in claim 6, further comprising a spring member supported between said circuit board and said lens to force said lens against said locating member.
